(19) United States
(12) Patent Application Publication
(10) Pub. No.: US 2017/0345052 A1
(43) Pub. Date: Nov. 30, 2017

(54) METHOD AND SYSTEM FOR IDENTIFYING ANOMALOUS CONTENT REQUESTS

(71) Applicant: comScore, Inc., Reston, VA (US)

(72) Inventors: Paul BARFORD, Reston, VA (US); Jeffery KLINE, Reston, VA (US)

(21) Appl. No.: 15/163,683

(22) Filed: May 25, 2016

(51) Int. Cl. G06Q 30/02; H04L 12/26

(52) U.S. Cl. CPC G06Q 30/0248; H04L 43/10

(57) ABSTRACT

Systems and methods for identifying anomalous content requests are disclosed. Initially, a first data set containing a first plurality of attributes for each of a first plurality of content requests is received. A second data set containing a second plurality of attributes for each of the first plurality of content requests is also received, where the second plurality of attributes is different from the first plurality of attributes. A first attribute of the first plurality of attributes is determined that is indicative of a first type of anomalous content request. It is then determined that the first attribute of the first plurality of attributes is common to the second plurality of attributes. A first subset of the second data set having the first attribute is then identified. Finally, content requests of the first subset of the second data set having the first attribute are indicated.

### FIELD OF THE DISCLOSURE

This disclosure generally relates to managing content requests associated with webpage advertisements, and more particularly to identifying anomalous content requests, such as for webpage advertisements, based on two or more sources of data.

### BACKGROUND

A company that provides goods or services, or a non-profit entity advancing a particular cause, for example, may pay a website owner, known as a publisher or content provider, to include their advertisements (interchangeably referred to herein as “creatives” and including, for example, text, images, video, etc.) into one or more of the content provider's webpages. A creative provider may have its creatives delivered through multiple content providers or third-party advertising networks/brokers. The content provider may display creatives from multiple creative providers or third party advertising networks/brokers on any one of its webpages.

The company paying the content provider to display the company's creative on the content provider's website, however, does not want to pay for instances of display that do not reflect a genuine display of the creative to a potential customer. Fraudulent content providers or other third parties may employ a number of different techniques to inflate the number of times that a creative is displayed on a content provider's website or otherwise manipulate the data that is intended to reflect the instances of display of the creative. Such techniques may include a fraudulent content provider implementing hidden or stacked creatives on the content provider's website that do not actually display the creative to the website viewer but may still be reflected in data that is intended to represent the number of times that the creative is displayed. Other techniques may include the use of so-called “click farms” in which workers manually visit websites containing creatives for the sole purpose of inflating the data representing the number of times that the creatives were displayed. Click farm workers may further perform clicks on the creatives to inflate the data representing the number of times the creatives were clicked.

Accordingly, there is a need for improved methods and systems to accurately identify fraudulent or otherwise anomalous content requests.

### SUMMARY OF THE DISCLOSURE

The foregoing needs are met, to a great extent, by the computer-implemented method for identifying anomalous content requests described below. Initially, a first data set containing a first plurality of attributes for each of a first plurality of content requests is received. A second data set containing a second plurality of attributes for each of the first plurality of content requests is also received, where the second plurality of attributes is different from the first plurality of attributes. A first attribute of the first plurality of attributes is determined that is indicative of a first type of anomalous content request. It is then determined that the first attribute of the first plurality of attributes is common to the second plurality of attributes. A first subset of the second data set having the first attribute is then identified. Finally, content requests of the first subset of the second data set having the first attribute are indicated.

In some aspects, the method can further include determining that a second attribute of the first plurality of attributes is indicative of a second type of anomalous content request and determining that the second attribute of the first plurality of attributes is not common to the second plurality of attributes. A second subset of the first data set having the second attribute can then be identified. A third attribute of the first plurality of attributes of the second subset of the first data set can be determined. It can be determined that the third attribute of the first plurality of attributes of the second subset of the first data set is common to the second plurality of attributes. A third subset of the second data set having the third attribute can be identified. Content requests of the third subset of the second data set having the third attribute can finally be indicated.

In some aspects, the number of the first plurality of attributes can be greater than the number of the second plurality of attributes, and the first plurality of attributes can include all of the second plurality of attributes.

In some aspects, the method can further include receiving a third data set containing a third plurality of attributes for each of the first plurality of content requests, where the third plurality of attributes is different than the first plurality of attributes and the second plurality of attributes. It can be determined that the first attribute of the first plurality of attributes is common to the third plurality of attributes. A second subset of the third data set having the first attribute can be identified. Content requests of the second subset of the third data set having the first attribute can be indicated.

In some aspects, the method can further include determining that a second attribute of the first plurality of attributes is indicative of a second type of anomalous content request and determining that the second attribute of the first plurality of attributes is not common to the third plurality of attributes. A third subset of the first data set having the second attribute can be identified. A third attribute of the first plurality of attributes of the third subset of the first data set can be determined and it can be further determined that the third attribute of the first plurality of attributes of the second subset of the first data set is common to the second plurality of attributes. A third subset of the second data set having the third attribute can be identified. Content requests of the third subset of the second data set having the third attribute can be indicated.

In some aspects, a first number of the first plurality of attributes can be greater than a second number of the second plurality of attributes, and the second number of the second plurality of attributes can be greater than a third number of the third plurality of attributes.

In some aspects, the third attribute can be at least one of a flagged IP address, a flagged ad-user agent, a flagged publisher, a flagged domain, a mobile device manufacturer, a model device model, a mobile device identifier, an application identifier, a browser plugin, a browser font, an operating system, a device language, a browser language, an identifier from a browser cookie, or a locale setting for a browser or the operation system.

In some aspects, the first data set can be received from a first source and the second data set can be received from a second source that is different from the first source. The third data set can be received from a third source that is different from the first source and the second source. The first source and the second source are each at least one of a source of ad tag based data, a source of census network based data, and a source of human panel based data. For example, the first source can be a source of ad tag based data and the second source is a source of census network based data. In another example, the first source can be a source of human panel based data and the second source is a source of census network based data.

In one example, the second attribute can be at least one of a visibility of a creative, an ID of a creative, a campaign ID of a creative, a traffic source partner, an account identifier on an ad network, a domain to which an ad placement is attributed, a content publisher to which an ad placement is attributed, a node hosting the ad, and a URL query parameter. In another example, the second attribute can be at least one of a process name, a user agent, a client device browsing history, a URL, a referrer, and a timestamp.

In some aspects, the first type of anomalous content request is at least one of requests corresponding to botnets, requests corresponding to click farms, requests corresponding to pay-per-view networks, requests corresponding to domain laundering, requests corresponding to ad stacking, requests corresponding to hidden ads, requests corresponding to adware traffic, requests corresponding to content scrapers, and requests corresponding to data center traffic.

In some aspects, indicating the content requests of the first subset of the second data set having the first attribute can include removing the first subset of the second data set from the second data set. In other aspects, indicating the content requests of the first subset of the second data set having the first attribute can include flagging the first subset of the second data set.

A system for identifying anomalous content requests, where the system includes at least one processor connected to at least one storage device is also disclosed according to some aspects. An article of manufacture including non-transitory machine-readable media having instructions encoded thereon is also disclosed according to some aspects.

Certain aspects of identifying anomalous content requests have been outlined such that the detailed description thereof herein may be better understood and in order for the present contribution to the art may be better appreciated. There are, of course, additional aspects of the disclosure that will be described below and which will form the subject matter of the claims appended hereto.

In this respect, before explaining at least one aspect of identifying anomalous content requests in detail, it is to be understood that the identifying anomalous content requests is not limited in its application to the specific steps or details set forth in the following description or illustrated in the drawings. Rather, other aspects in addition to those described can be practiced and carried out in various ways. Also, it is to be understood that the phraseology and terminology employed herein, as well as the Abstract, are for the purpose of description and should not be regarded as limiting.

As such, those skilled in the art will appreciate that the conception upon which this disclosure is based may readily be utilized as a basis for the designing other structures, methods, and systems for carrying out the several purposes of the identifying anomalous content requests. It is important, therefore, that the claims be regarded as including such equivalent constructions insofar as they do not depart from the spirit and scope of the disclosure.

### BRIEF DESCRIPTION OF THE DRAWINGS

In order that the disclosure may be readily understood, aspects of this disclosure are illustrated by way of examples in the accompanying drawings.

FIG. 1 illustrates an exemplary hardware and network configurations between a content provider, a creative provider, an analysis network and a client device.

FIG. 2 illustrates an exemplary webpage of a content provider.

FIG. 3 illustrates an example of a process for identifying anomalous content requests.

FIG. 4 illustrates another example of a process for identifying anomalous content requests.

The same reference numbers are used in the drawings and the following detailed description to refer to the same or similar parts.

### DETAILED DESCRIPTION

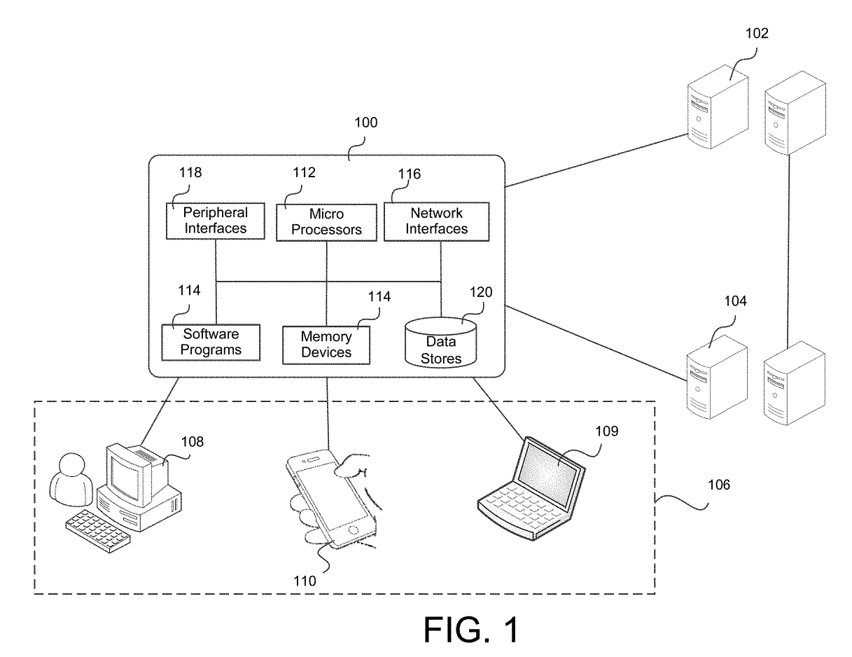

FIG. 1 illustrates exemplary hardware and network configurations for various devices that may be used to perform one or more operations of the described aspects. As shown, a content provider 100, a creative provider 102, and an analysis network 104 are in communication with one another. A content provider 100 may be a website owner or content publisher. The creative provider 102 may be a company seeking to market or sell products or services, or an advertisement agency or broker that may provide advertisements (i.e., creatives) to a content provider 100. The analysis network 104 may be a third-party seeking to receive information related to the advertisements received by the content provider 100 and assist the creative provider 102 in the delivery of a creative.

The content provider 100 may be in communication with a plurality of client devices 106. A client device 106 may be viewing a webpage or other web or application content of the content provider 100. As further described below, the client devices 106 may be the devices that receive an advertisement. The client devices 106 may include a personal computing device, such as a desktop 108 or laptop computer 109, a mobile device 110, such as a smartphone or tablet, a kiosk terminal, a Global Positioning System (GPS) device, etc. The client device 106 may receive client-side code to render a webpage from one or more external devices, such as a web server involved with serving webpages, advertisements, creative, or other information to the client device.

Although only the hardware configurations for the content provider 100 are shown in FIG. 1, each of the content provider 100, the creative provider 102, the analysis network 104, and the client devices 106 may include microprocessors 112 of varying core configurations and clock frequencies. These entities may also include one or more memory devices or computer-readable media 114 of varying physical dimensions and storage capacities, such as flash drives, hard drives, random access memory, etc., for storing data, such as images, files, and program instructions for execution by one or more microprocessors 112. These entities may include one or more network interfaces 116, such as Ethernet adapters, wireless transceivers, or serial network components for communicating over wired or wireless media using protocols, such as Ethernet, wireless Ethernet, code divisional multiple access (CDMA), time division multiple access (TDMA), etc. These communication protocols may be used to communicate between the content provider 100, the creative provider 102, the analysis network 104, and the client devices 106. These entities may also have one or more peripheral interfaces 118, such as keyboards, mice, touchpads, computer screens, touchscreens, etc. for enabling human interaction with and manipulation of devices of the content provider 100, the creative provider 102, the analysis network 104, and the client devices 106.

The content provider 100, the creative provider 102, the analysis network 104, and the client devices 106 may each have the computer-readable media 114 physically or logically arranged or configured to provide for or store one or more data stores 120, such as one or more file systems or databases, and one or more software programs 122, which may contain interpretable or executable instructions for performing one or more of the disclosed aspects. The components may comprise any type of hardware, including any necessary firmware or software for performing the disclosed aspects. The components may also be implemented in part or in whole by electronic circuit components or processors, such as application-specific integrated circuits (ASIC) or field-programmable gate arrays (FPGAs).

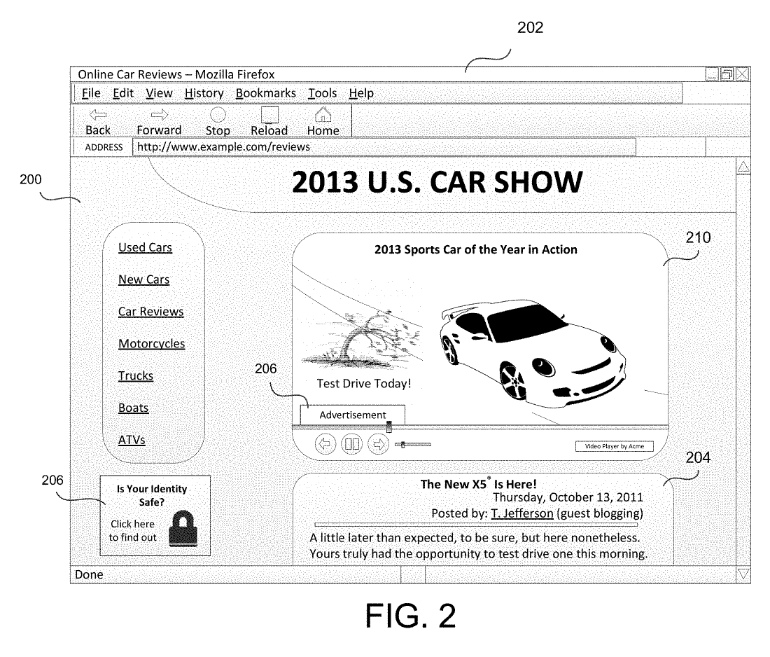

FIG. 2 is a diagram depicting an exemplary webpage 200 of the content provider 100. The webpage 200 may be rendered by a web browser 202 on a client device 106 and displayed on a screen of the client device 106. The webpage 200 may include content 204 and at least one creative 206. The creative 206 may be a static advertisement (e.g., text or image), an animated advertisement, a dynamic advertisement, a video advertisement, a public service announcement, or another form of information to be displayed on a screen of the client device 106.

In order to render the creative 206, the markup language of the webpage 200 may include a creative tag associated with the desired creative 206. For example, if the webpage 200 is coded with HyperText Markup Language (HTML), the creative tag may be an HTML tag or JavaScript tag that links to the creative 206. The creative tag may direct the client device 106 to retrieve the creative 206 from a creative provider 102. The location for the creative 206 may be embedded anywhere within the HTML text or within an iFrame that has been placed in the webpage 200. The webpage 200 may have one or more such locations for the display of the creative 206. It will be appreciated that the creative tag may be a series of successive links that ultimately redirect to the creative 206. As used herein, the term creative link includes both a direct link to the creative 206 as well as a series of successive links to the creative 206 through, for example, one or more advertisement networks.

Further, the webpage 200 may have instructions for embedding a video player 210 as a part of the content to be displayed on the page. The video player 210 may be configured to play video content, such as video advertisements, to open executable files, such as Shockwave Flash files, or to execute other instructions. The video player 210 may be a separate component that is downloaded and executed by the web browser 202, such as an Adobe Flash, Apple QuickTime, or Microsoft Silverlight object; a component of the web browser 202 itself, such as a HTML 5.0 video player; or any other type of component able to render and play video content within the web browser 202. The video player may be configured to play featured video content in addition to a creative 206. The video player may also be configured to retrieve the creative 206 through a creative tag that links to the desired creative 206.

The content provider 100, the creative provider 102, the analysis network 104, or other party may track each time the webpage 200, a creative 206, or other web content (e.g., metadata relating to the content of the webpage 200 and/or the creative 206) is fetched from its source and/or delivered to a client device 106. The fetching and/or delivery of the webpage 200, the creative 206, or other web content is hereinafter referred to as a “content request.”

In addition to simply counting the number of content requests for the webpage 200 or the number of impressions of a creative 206, the content provider 100, the creative provider 102, the analysis network 104, or other party may track one or more attributes relating to the content requests. For example, an attribute that relates to a content request may include an identification of the operating system of the client device 106, an identification of a web browser, an identification of a plugin or font installed in a web browser, a language used in a web browser or the client device 106, a locale setting on the client device 106, an IP address (e.g., an IPv4 (Internet Protocol version 4) address or an IPv6 (Internet Protocol version 6) address) of the client device 106, a MAC address of the client device 106, a domain of the creative 206, an ad-user agent identity, a particular content provider 100, a particular creative provider 102, a time and/or date of the content request, or demographic information related to a user of the client device 106 (e.g., age, sex, ethnicity, income level, geographic location, etc.). An attribute described herein or other information may be ascertained based on information from a browser cookie. For instance, the identification of a user and/or the user's web browser may be determined using a browser cookie stored on the client device 106. Other examples of an attribute include whether the creative 206 or other webpage content is visible, an ID of the creative 206, a campaign ID of the creative 206, a traffic source partner, an account identifier on an ad network, a domain or content publisher to which the creative 206 placement is attributed, a node hosting the creative 206, and a URL query parameter. Further examples of an attribute include a mobile device's (i.e., a mobile device used as a client device 106) manufacturer, model, or device ID (e.g., IDFA (Identifier for Advertising) or AAID (Google Advertising ID)) or an application (“app”) or package used on a mobile device.

It will be appreciated that an attribute of a content request may be a composite attribute (i.e., an attribute indicative of more than one base attribute). For example, a composite attribute may be indicative of a web browser plugin and a web browser or operating system. As a more particular example, an attribute may indicate that a Flash plugin was used in association with a content request and that the client device 106 associated with the content request was using an iOS operating system. As the Flash plugin and the iOS operating system are generally incompatible, this may indicate that the content request is anomalous and/or fraudulent.

The tracked content request data, including attributes relating to content requests, gathered by the content provider 100, the creative provider 102, the analysis network 104, or other entity may be used for a variety of purposes including identifying anomalous or fraudulent content requests.

The content requests, attributes thereof, and other information relating to the content requests may be tracked and recorded in one or more data sets gathered according to one or more sources. The data sets may reflect the same sample of content requests, yet be gathered according to different data sources. The data (e.g., attributes of the content requests embodied in the data set) in each of the data sets may include data common to more than one of the data sets. For example, an attribute of a content request may be reflected in both a first data set and a second data set, wherein the first data set and the second data set are gathered according to different sources. Yet, one data set may include attributes not included in another data set, e.g., the number of attributes in one data set may be greater or less than the number of attributes in another data set.

One or more data sets may be used for billing purposes. For instance, the analysis network 104 may use one or more of the data sets to determine the number of times a particular creative provider's 102 creative was displayed on a particular content provider's 100 webpage. The analysis network 104 may then bill the creative provider 102 for the corresponding amount, which, in turn, may be paid out to the content provider 100.

One type or source of a data set, referred to herein as ad tag data, is derived from the operation of a creative tag to cause a content request. As discussed above, a creative tag may be an HTML or JavaScript tag that is included in a content provider's 100 webpage and causes the client device 106 with which the webpage is being accessed to initiate a content request for the associated creative from the creative provider 102. The content request, and attributes thereof, initiated by the creative tag may be tracked by the content provider 100, the creative provider 102 and/or the analysis network 104, and stored as the ad tag data. As an example, a creative tag included in the HTML of the webpage 200 of FIG. 2 causes a content request for the creative 206 to be retrieved from the creative provider 102. The content request, and attributes thereof, for the creative 206 may be reflected in ad tag data. For instance, the content request for the creative 206, and subsequent delivery of the creative 206, may be routed via the analysis network 104, wherein the analysis network 104 tracks and records the content request, and attributes thereof, for the creative 206 in ad tag data.

A second type or source of a data set, referred to herein as census network data, is derived by operation of a content request for web site content other than creative content. Census network data may represent content request activity concerning the substantive content of a webpage. For example, if a website is primarily concerned with sports, census network data may reflect that a user viewed a webpage of said website containing a particular sports story. To gather census network data, the HTML—or other protocol embodying a webpage—may include a content tag that, when the webpage is rendered by the client device 106, initiates a content request for an associated article of non-creative content, such as from a content provider 100. The content request, and attributes thereof, for the non-creative content initiated by the content tag may be tracked, such as by the content provider 100, the creative provider 102 and/or the analysis network 104, and stored as census network data.

In some aspects, census network data may reflect a content request for hidden content not visually displayed on a webpage but still considered part of the webpage. For example, the HTML for a webpage may contain an image tag for a transparent image with a size of one pixel by one pixel. When the webpage is rendered by the client device 106, a content request is made for the transparent image, such as to the content provider 100 or analysis network 104. While the transparent image is not visible to a user, the transparent image is nonetheless rendered by the web browser of the client device 106. The content request, and attributes thereof, for the transparent image (and/or the subsequent delivery of the transparent image to the client device 106) may be tracked and represented in the census network data.

The census network data may be gathered by an intermediate entity, such as an analysis network 104, between the client device 106 and the content provider 100. In an aspect, the analysis network 104 is embodied as a census network in which the census network gathers and tracks non-creative content request activity from a large pool of websites.

Yet another type or source of a data, referred to herein as human panel data, is derived from a network of instrumentation in which human users have consented to said instrumentation tracking. For example, a user may install a software program on their client device 106 that tracks and records the user's web browsing activity or other online activity, such as mobile device application use. Tracked web browsing activity may include, but is not limited to, webpage(s) visited, the date and/or time that a webpage is visited, the duration that a webpage is viewed, whether a video was viewed on a webpage, and what, if any, clicks the user performs on a webpage. In addition to the tracked activity, a user may further provide their demographic information, such as name, age, gender, ethnicity, geographic location, income, familial or marital status, and/or hobbies. Further, information on the user's client device 106 may be provided, such as hardware configuration, operating system, and web browser software and version thereof. The information on the user's client device 106 may be explicitly provided by the user or may be automatically ascertained by the instrumentation, such as by a software program installed on the client device 106. Thus, the human panel data may include tracked web browsing activity of a user as well as correlated demographic information and/or client device 106 information associated with the user. The human panel data for an individual user and/or client device 106 may be reported to a central entity, such as the analysis network 104, where it may be aggregated with human panel data relating to other users and/or respective client devices 106.

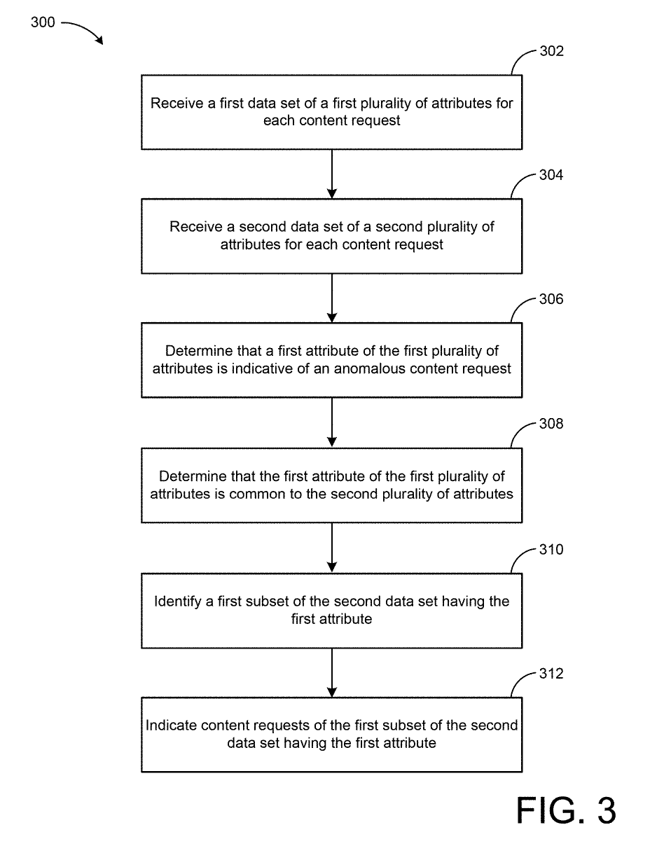

FIG. 3 illustrates an example of a process 300 for identifying anomalous or fraudulent content requests. The process 300 may be performed, for example, by the analysis network 104.

At step 302, a first data set is accessed or received, such as by the analysis network 104, that reflects a first plurality of content requests. The first plurality of content requests may be, for example, the content requests in a particular period of time. The first plurality of content requests may further be the content requests associated with a particular creative or campaign of creatives. The first data set includes a first plurality of attributes that are each associated with one of the first plurality of content requests. A content request of the first plurality of content requests may be associated with more than one attribute of the first plurality of attributes. As described above in greater detail, an attribute may include any information relating to a content request, such as the IP address from which a content request is made, the type of web browser used, a plugin installed on the web browser, demographic information of a user, etc. The first data set may be one of the types of data set discussed herein (e.g., ad tag data, census network data, or human panel data) or another type of data set.

At step 304, a second data set is also accessed or received, such as by the analysis network 104. Similar to the first data set, the second data set includes a second plurality of attributes that are each associated with one of the first plurality of content requests. The second plurality of attributes is at least partially different from the first plurality of attributes, although there may be some coincidence between the first plurality of attributes and the second plurality of attributes. In an aspect, the second data set may be one of the types of data sets described above (e.g., ad tag data, census network data, or human panel data) or another type of data set. Further, the type or source of the second data set may be different than the type or source of the first data set. For example, the first data set may be ad tag data and the second data set may be census network data.

At step 306, it is determined that a first attribute of the first plurality of attributes is indicative of an anomalous or fraudulent content request and/or type thereof. The determination of the first attribute of the first plurality of attributes as indicative of an anomalous or fraudulent content request may be performed according to a variety of techniques. As one example, first data set may be ad tag data and the first attribute may indicate that the creative content request is from a flagged IP address known to be used by a click farm to artificially inflate the number of creative impressions. Other types or anomalous or fraudulent requests include requests corresponding to botnets, requests corresponding to click farms, requests corresponding to pay-per-view networks, requests corresponding to domain laundering, requests corresponding to ad stacking, requests corresponding to hidden ads, requests corresponding to adware traffic, requests corresponding to content scrapers, and requests corresponding to data center traffic.

One exemplary method of determining that the first attribute of the first plurality of attributes is indicative of an anomalous or fraudulent content request and/or type thereof is, generally, to compare a data pattern that is known to represent genuine (i.e., non-anomalous and/or non-fraudulent) content requests with aspects of the first data set, including the first plurality of attributes and the first attribute thereof.

Such a method includes accessing, generating, or receiving a model distribution of a plurality of data points for at least one content request attribute, wherein the plurality of data points represent content requests that are known to be genuine. Generating the model distribution may include selecting an attribute, such as the attribute type of the aforementioned first attribute, and accessing or receiving the plurality of data points for the selected attribute. The model distribution may be generated using the plurality of data points for the selected attribute according to one or more techniques, such as aggregating the data, statistical binning, fitting a probability mass function, or fitting a probability density function.

Having already accessed or received the first data set reflecting the first plurality of content requests, an empirical distribution of a plurality of datapoints for the above-selected attribute may be generated. The empirical distribution may be generated according to a similar method as described above in relation to the model distribution.

The exemplary method of determining that a first attribute of the first plurality of attributes is indicative of an anomalous or fraudulent content request further includes determining a minimum number of data points to remove from the empirical distribution to correspond with the model distribution within a certain confidence level. Determining the minimum number of data points to remove may include removing a number of data points from the empirical distribution to generate a plurality of modified distributions, which are then compared with the model distribution to determine a plurality of divergences between the modified distributions and the model distribution. Each divergence may be a measure of the difference between the modified empirical distribution and the model distribution or a statistical distance between the modified empirical distribution and the model distribution, such as a squared Hellinger distance, a Jeffrey's divergence, a Kullback-Leibler divergence, or a Kagan's divergence.

A minimum divergence determined from the plurality of divergences is then compared with a confidence level. If the minimum divergence is greater than the confidence level, the modified empirical distribution may be considered to not correspond with the model distribution within a desired significance level and the modified empirical distribution likely still contains potentially anomalous or fraudulent content requests. In such a case, the process of determining the minimum number of data points to remove from the empirical distribution may be repeated with an increase to the number of data points removed from the empirical distribution. If the minimum divergence is less than the confidence level, the data points removed from the empirical data may be considered to correspond with anomalous or fraudulent content requests. For example, the first attribute of the first plurality of content requests may be one of (or correspond thereto) the datapoints removed from the empirical distribution.

At step 308, it is determined that the first attribute of the first plurality of attributes of the first data set is common to the second plurality of attributes of the second data set. By the term “common,” it is meant that at least one attribute of the second plurality of attributes corresponds to the first attribute of the first plurality of attributes. For example, a data set of ad tag data (as the first data set) may include a particular IP address (as the first attribute) corresponding to a particular content request. It may be determined that a data set of census network data (as the second data set) also includes that particular IP address for the content request.

At step 310, a first subset of the second data set is identified that has the first attribute, which was identified in step 306 as indicative of an anomalous or fraudulent content request. By identifying the first subset of the second data that has the first attribute, the determination that the first attribute is indicative of an anomalous content may be validated, thus allowing an entity, such as the analysis network 104, to be increasingly confident that the content requests (e.g., creative content requests) for which another entity, such as the creative provider 102, is billed are genuine content requests. Continuing the example from step 308 in which the first attribute is a particular IP address, a first subset of the census network data may be identified such that it includes data associated with one or more content requests having the particular IP address attribute. This determination may represent a confirmation that a set of content requests coming from the IP address, which may have been flagged as belonging to a fraudulent source (e.g., a click farm or hijacked computer), are indeed anomalous or fraudulent.

At step 312, content requests of the first subset of the second data set are indicated. In this step, data of the first subset of the second data set may be correlated with the corresponding content requests from the first plurality of content requests. The content requests of the first subset of the second data may be indicated to an entity responsible for compiling a record of content requests for billing purposes. For example, the analysis network 104 may compile a record of non-anomalous or non-fraudulent content requests and present it to the creative provider 102 so that the creative provider 102 may provide payment to the content provider 100 for the creative impressions that occurred on the content provider's 100 website. As such, as part of indicating the content requests of the first subset of the second data set, the first subset of the second data set may be removed from the second data set, thereby removing the data relating to content requests that are believed to be anomalous or fraudulent from the second data set. In some aspects, indicating the content requests of the first subset of the second data having the first attribute comprises flagging the first subset of the second data. The flagged first subset of the second data may thus, for example, not be considered for billing purposes.

It will be appreciated that the process 300 may be similarly performed with more than two data sets and types thereof. For example, the process 300 may further include receiving a third data set containing a third plurality of attributes for each of the first plurality of content requests. In an aspect, the third plurality of attributes is at least partially different than both the first plurality of attributes and the second plurality of attributes. The third data set may be any one of the types of data sets described herein (e.g., ad tag data, census network data, or human panel data) or another type of data set. Further, the type or source of the third data set may be different than the type or source of the first data set and the second data set. For instance, the first data set may be ad tag data, the second data set may be census network data, and the third data set may be human panel data.

In an aspect, the process 300 may further include determining that the first attribute of the first plurality of attributes is common to the third plurality of attributes and identifying a second subset of the third data set having the first attribute. For example, a flagged IP address attribute in the ad tag data (the first data set) may be used to identify content requests also with the flagged IP address attribute in the human panel data (the third data set). The content requests of the second subset that have the first attribute may be indicated.

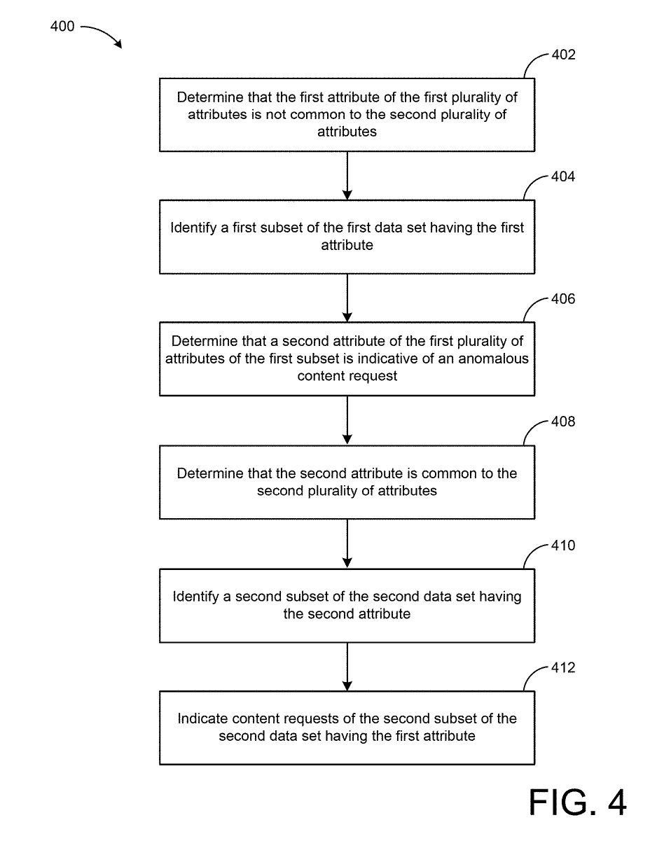

In another aspect, if it is determined in step 308 that the first attribute of the first plurality of attributes is not common to the second plurality of attributes of the second data set, the process 400 shown in FIG. 4 may be initiated. At step 402, as already mentioned, it is determined that the first attribute of the first plurality of attributes is not common to the second plurality of attributes. That is, the first attribute from the first data set is not found in the plurality of attributes of the second data set. For example, an attribute indicating the web browser used in a content request (the first attribute) in human panel data (the first data set) may not be tracked in ad tag data (the second data set).

At step 404, a first subset of the first data set having the first attribute is identified. By identifying the subset of the first data set having the first attribute, the first data set may be refined to eliminate data corresponding to attributes that are now known to be absent from the second data set.

At step 406, a second attribute of the first plurality of attributes of the first subset of the first data set is determined to be indicative of an anomalous or fraudulent content request. That is, another attribute from the refined first data set is determined to be indicative of an anomalous or fraudulent content request. The determination that the second attribute is indicative of an anomalous or fraudulent content request may be performed according to the exemplary techniques described in relation to step 306 of the process 300 shown in FIG. 3.

At step 408, it is determined that the second attribute determined in step 406 is common to the second plurality of attributes of the second data set. If it is determined that the second attribute is not common to the second plurality of attributes of the second data, the process 400 may be repeated recursively, identifying progressively more refined subsets of the first data set with each iteration until a common attribute is identified. If it is determined that the second attribute is common to the second plurality of attributes of the second data set, the process 400 may continue on to step 410.

At step 410, a second subset of the second data set having the second attribute, which was identified in step 406 as indicative of an anomalous or fraudulent content request, is identified. At step 412, content requests of the second subset of the second data set, identified in step 410, are indicated. The indication of the content requests may be performed in a similar manner as that described above with respect to step 312 of the process 300 shown in FIG. 3.

It will be appreciated that the order in which the steps of the processes 300 and 400 are performed is not limited to the ordering depicted in FIGS. 3 and 4. For example, step 308, in which it is determined that the first attribute from the first data set is common to the second plurality of attributes of the second data set, may readily be performed before step 306, in which the first attribute is determined to be indicative of an anomalous or fraudulent content request. Similarly, the ordering of steps 406 and 408 may readily be reversed.

Certain aspects of the processes 300 and 400 and other operations described herein may be implemented as or using a computer program or set of programs. The computer programs may exist in a variety of forms both active and inactive. For example, the computer programs may exist as software program(s) comprised of program instructions in source code, object code, scripts, executable code or other formats, firmware programs(s), or hardware description language (HDL) files. Any of the above may be embodied on a non-transitory computer readable medium, which include storage devices, in compressed or uncompressed form. Exemplary computer readable storage devices may include conventional computer system random access memory (RAM), read-only memory (ROM), erasable, programmable memory (EPROM), electrically erasable, programmable memory (EEPROM), and magnetic or optical disks or tapes.

Certain aspects of the processes 300 and 400 and other operations described herein may utilize or include a computer system, which may include one or more processors coupled to memories operating under control of or in conjunction with an operating system. The processors may be included in one or more servers, clusters, or other computers or hardware resources, or may be implemented using cloud-based resources. The processors may be programmed or configured to execute computer-implemented instructions to perform the steps of the processes disclosed herein.

While the process for identifying anomalous content requests has been described in terms of what may be considered to be specific aspects, this disclosure need not be limited to the disclosed aspects. Additional modifications and improvements may be apparent to those skilled in the art. As such, this disclosure is intended to cover various modifications and similar arrangements included within the spirit and scope of the claims, the scope of which should be accorded the broadest interpretation so as to encompass all such modifications and similar methods. The present disclosure should be considered as illustrative and not restrictive.

1. A computer-implemented method for identifying anomalous content requests, the method comprising:
receiving a first data set containing a first plurality of attributes for each of a first plurality of content requests;
receiving a second data set containing a second plurality of attributes for each of the first plurality of content requests, the second plurality of attributes being different from the first plurality of attributes;
determining that a first attribute of the first plurality of attributes is indicative of a first type of anomalous content request;
determining that the first attribute of the first plurality of attributes is common to the second plurality of attributes;
identifying a first subset of the second data set having the first attribute; and
indicating content requests of the first subset of the second data set having the first attribute.

2. The method of claim 1, further comprising:
determining that a second attribute of the first plurality of attributes is indicative of a second type of anomalous content request;
determining that the second attribute of the first plurality of attributes is not common to the second plurality of attributes;
identifying a second subset of the first data set having the second attribute;
determining that a third attribute of the first plurality of attributes of the second subset of the first data set is indicative of a third type of anomalous content request;
determining that the third attribute of the first plurality of attributes of the second subset of the first data set is common to the second plurality of attributes;
identifying a third subset of the second data set having the third attribute; and
indicating content requests of the third subset of the second data set having the third attribute.

3. The method of claim 1, wherein the number of the first plurality of attributes is greater than the number of the second plurality of attributes.

4. The method of claim 3, wherein the first plurality of attributes includes all of the second plurality of attributes.

5. The method of claim 1, further comprising:
receiving a third data set containing a third plurality of attributes for each of the first plurality of content requests, the third plurality of attributes being different than the first plurality of attributes and the second plurality of attributes;
determining that the first attribute of the first plurality of attributes is common to the third plurality of attributes;
identifying a second subset of the third data set having the first attribute; and
indicating content requests of the second subset of the third data set having the first attribute.

6. The method of claim 5, further comprising:
determining that a second attribute of the first plurality of attributes is indicative of a second type of anomalous content request;
determining that the second attribute of the first plurality of attributes is not common to the third plurality of attributes;
identifying a third subset of the first data set having the second attribute;
determining that a third attribute of the first plurality of attributes of the third subset of the first data set is indicative of a third type of anomalous content request;
determining that the third attribute of the first plurality of attributes of the second subset of the first data set is common to the second plurality of attributes;
identifying a third subset of the second data set having the third attribute; and
indicating content requests of the third subset of the second data set having the third attribute.

7. The method of claim 6, wherein:
a first number of the first plurality of attributes is greater than a second number of the second plurality of attributes, and
the second number of the second plurality of attributes is greater than a third number of the third plurality of attributes.

8. The method of claim 6, wherein the third attribute is at least one of a flagged IP address, a flagged ad-user agent, a flagged publisher, a flagged domain, a mobile device manufacturer, a mobile device model, a mobile device identifier, an application identifier, a browser plugin, a browser font, an operating system, a device language, a browser language, an identifier from a browser cookie, and a locale setting for a browser or the operating system.

9. The method of claim 5, wherein the first data set is received from a first source, the second data set is received from a second source that is different from the first source, and the third data set is received from a third source that is different from the first source and the second source.

10. The method of claim 9, wherein the first source and the second source are each at least one of a source of ad tag based data, a source of census network based data, and a source of human panel based data.

11. The method of claim 10, wherein the first source is a source of ad tag based data and the second source is a source of census network based data.

12. The method of claim 11, wherein the second attribute is at least one of a visibility of a creative, an ID of a creative, a campaign ID of a creative, a traffic source partner, an account identifier on an ad network, a domain to which an ad placement is attributed, a content publisher to which an ad placement is attributed, a node hosting the ad, and a URL query parameter.

13. The method of claim 1, wherein the first type of anomalous content request is at least one of the following: requests corresponding to botnets, requests corresponding to click farms, requests corresponding to pay-per-view networks, requests corresponding to domain laundering, requests corresponding to ad stacking, requests corresponding to hidden ads, requests corresponding to adware traffic, requests corresponding to content scrapers, and requests corresponding to data center traffic.

14. The method of claim 1, wherein the first data set is received from a first source and the second data set is received from a second source that is different from the first source.

15. The method of claim 14, wherein the first source is a source of human panel based data and the second source is a source of census network based data.

16. The method of claim 15, wherein the second attribute is at least one of the following: a process name, a user agent, a client device browsing history, a URL, a referrer, and a timestamp.

17. The method of claim 1, wherein indicating the content requests of the first subset of the second data set having the first attribute comprises removing the first subset of the second data set from the second data set.

18. The method of claim 1, wherein indicating the content requests of the first subset of the second data set having the first attribute comprises flagging the first subset of the second data set.

19. A system for identifying anomalous content requests, the system comprising one or more processors connected to at least one storage device, the system being configured to:
receive a first data set containing a first plurality of attributes for each of a first plurality of content requests;
receive a second data set containing a second plurality of attributes for each of the first plurality of content requests, the second plurality of attributes being different from the first plurality of attributes;
determine that a first attribute of the first plurality of attributes is indicative of a first type of anomalous content request;
determine that the first attribute of the first plurality of attributes is common to the second plurality of attributes;
identify a first subset of the second data set having the first attribute; and
indicate content requests of the first subset of the second data set having the first attribute.

20. A storage device storing a computer program for identifying anomalous content requests, the computer program comprising one or more code segments that, when executed, cause one or more processors to:
receive a first data set containing a first plurality of attributes for each of a first plurality of content requests;
receive a second data set containing a second plurality of attributes for each of the first plurality of content requests, the second plurality of attributes being different from the first plurality of attributes;
determine that a first attribute of the first plurality of attributes is indicative of a first type of anomalous content request;
determine that the first attribute of the first plurality of attributes is common to the second plurality of attributes;
identify a first subset of the second data set having the first attribute; and
indicate content requests of the first subset of the second data set having the first attribute.
